(19) United States
(12) Patent Application Publication
(10) Pub. No.: US 2009/0267035 A1
(43) Pub. Date: Oct. 29, 2009

(54) Apparatus having a selectively engagable fastener set

(76) Inventors: Graham P. Wood, Torrance, CA (US); Kennith C. Hall, Torrance, CA (US)

Correspondence Address: PATENT LAW & VENTURE GROUP, 2424 S.E. BRISTOL, SUITE 300, NEWPORT BEACH, CA, 92660, US

(21) Appl. No.: 12/150,689

(22) Filed: Apr. 29, 2008

(51) Int. Cl. B66F 3/08; F16B 37/10

(52) U.S. Cl. 254/98; 411/433

(57) ABSTRACT

A selectively engagable nut made up of plural nut portions which are able to move apart for disengagement with a screw and to move together to reengage. The nut portions are driven by pins extending into slots on the nut portions; the pins mounted in a rotating collar adjacent to the nut. The collar's pins, in a first rotational position holds the nut portions engaged with the screw. In an alternative rotational position, the pins drive and hold the nut portions apart to disengage with the nut portions. When the nut portions are in mutual contact, fingers are positioned on the nut portions in positions preventing the nut portions from moving apart so as to disengage the nut from the screw.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### REFERENCE TO A “MICROFICHE APPENDIX”

Not applicable.

### SEQUENCE LISTING

Not applicable.

### BACKGROUND OF THE INVENTION

1. Field of the Present Disclosure

This disclosure relates generally to threaded drives and gear assemblies and, more particularly, to a selectively engagable threaded fastener set, particularly a nut and screw which cooperate for quick release.

2. Description of Related Art Including Information Disclosed Under 37 CFR 1.97 and 1.98

Thomas, US D340566, discloses an ornamental design for a vehicle mounted jack.

Garceau, US 2007/0114502, discloses a motor drive for camper jacks or screw jacks that rapidly operates the screw jack between a retracted position and an extended no load position. A manual operator then operates the screw jack between the extended no load position and an extended loaded position. The motor drive and manual operator share a right angle gear mechanism.

Douglass, U.S. Pat. No. 3,595,527, discloses an elongated upright tubular support of square cross section that is fastened to the trailer tongue between the trailer body and the outer end of the tongue where the usual socket for a ball and socket coupler is located. An elongated tubular jack body is supported in retracted position on top of said support and is slidable up and down in said support and has a series of radial projections therein which can be passed through a passageway in one corner portion of said support when extending the jack body downwardly to or retracting the same from operative position, these projections being adapted to be entered for a rough adjustment in L-shaped slots provided in said support and communicating by one leg of the L with said passageway. Then the jackscrew, operable from the upper end of said jack body adjusts the load carrying member that is slidable in the jack body to make the fine adjustment, seating one or two projections in the upper end of the slot or slots.

Zeranick et al., U.S. Pat. No. 4,078,470, discloses a split nut to enable complete separation of the longitudinal halves from a threaded shank so that they may be re-fitted to any other portion thereof, particularly long threaded shanks, without the necessity of turning the nut in threaded relationship to such selected position. It is particularly useful in the case of rusted threaded shanks involving great difficulty in screw-threading the nut on the rusted threads. A special feature of the present construction of the nut halves is that it enables the making of identical and interchangeable halves, which greatly reduces manufacturing and inventory costs.

Yelverton, U.S. Pat. No. 4,083,288, discloses a split nut formed from two substantially identical screw-threaded half nuts, each of which has chamfered ends, preferably at about 60° to the axis of the nut, to engage in a conical counter-bore of a washer or work piece. When the split nut is tightened it remains securely in place. Each half nut has side faces extending in radial planes with complementary locating means symmetrically disposed on either side of the central plane of the half nut taken at right angles to the axis, and the screw-thread has a start at one end only, whereby one of the half nuts is inverted so that the respective complementary locating means inter-engage to align axially the half nuts.

Adams, U.S. Pat. No. 4,238,113, discloses a jacking or lifting device for use with trailers or the like. The jacking device of the present invention is basically a two-piece structure comprised of a rough adjusting column which is spaced apart from and externally secured to the outside cylinder or housing of an otherwise conventional lifting jack. With this new construction, only relatively simple adjustments need to be made on the rough adjusting column, to enable the jacking device of the present invention to cover a wide range of lifting heights with minimum effort.

Osborne et al., U.S. Pat. No. 4,316,601, discloses a quick-adjusting jack stand apparatus particularly useful on any harvesting attachments. An improved jack stand has a coarse adjustment and a fine adjustment. Coarse adjustment is accomplished by moving the jack stand from a first stored position to a second extended position. A secondary fine adjustment is accomplished by rotating an inner member which is housed in and threadably engaged with an outer member. Such rotation results in extension of the inner member from the outer member. The threaded engagement of the members is protected from excessive clogging because such threaded engagement is within the outer member.

William, U.S. Pat. No. 4,462,731, discloses a split nut assembly for mounting on a threaded stud or screw without passing over the end of the stud or screw. The assembly consists of a nut divided into two equal parts and a shell equally divided. The shell when assembled fits over the nut so that the assembly can be rotated and tightened together. In a separate embodiment, lock nut capability is provided by providing tapered surfaces on the shell and the nut to force the latter radially against the stud or screw while the assembly is tightened in place. In another embodiment, a press fit arrangement is provided.

Wenzel, U.S. Pat. No. 4,597,561, discloses a lifting and depositing device for portable containers comprising a plurality of rack and pinion jacks, some of which are mounted on support legs of the container. Each rack and pinion jack has an accessory gearing which can be pivoted outwardly or removed, so that when accessory gearing is pivoted outwardly, a support leg can be manually moved axially relative to its guide part, if the container, e.g., is offset on the loading surface of a truck. Thus, the gearing operation and time-consuming crank work required until now for two idle strokes per work cycle is avoided.

McMahan, U.S. Pat. No. 4,842,252, discloses a three-piece telescoping jack that is capable of rapid coarse adjustments in height. The invention comprises first, second and third elongated tubular members that are somewhat nested in a telescoping relationship. The invention further comprises fine adjustment means for holding and adjusting the position of the second member in relation to the first and coarse adjustment means for holding and adjusting the position of the third member in relation to the second. The coarse adjustment means further allow the position of the third member to be rapidly adjusted, either retracted or extended, in relation to the second member. In a preferred embodiment, the fine adjustment means are a threaded nut and bolt. Also in a preferred embodiment, the coarse adjustment means are a pin and a series of holes in the second and third members.

Gipson, Jr., U.S. Pat. No. 4,978,104, discloses a quick-release rack and pinion safety jack assembly for mounting upon the tongue of a conventional trailer. The jack assembly comprises a vertical support stanchion extending upwardly from a rotatable caster, a rigid rack, and a weatherproof box-like gear housing penetrated by the stanchion. A rotatable hand crank is rotated to move the stanchion relative to the gear housing, to elevate or lower the trailer. The internal gear assembly comprises a worm gear driven by the hand crank and a drive gear driven by the worm which selectively meshes or unmeshes with the rack. The drive gear is mounted for rotation upon a rigid axle which penetrates elongated follower slots defined in opposite walls of the gear housing. The drive gear axle is coupled at its ends by rigid links rotatably anchored in a pivotal safety lever. The safety lever is manually deflectable along an arcuate path between a first lock position and a second released position. As the lever is deflected downwardly from its “locked” position, the drive gear moves horizontally along the worm out of engagement with the rack. When the lever is returned to its lock position, the drive gear rotates along the worm gear and then meshes with the rack. When the drive gear is unmeshed from the rack, the stanchion slides freely relative to the housing for height adjustments without cranking.

Haas et al., U.S. Pat. No. 5,000,640, discloses a split nut made of elastic material that deflects under manual pressure. Each nut half has a projecting bead and a keyhole recess. The beads removably fit into the keyhole recesses to hold the nut halves together. Radial fins permit rotation by air jet and enlarge the size of the nut halves to make manual disassembly easier.

Pittman, U.S. Pat. No. 5,174,550, discloses a screw jack incorporating a quick retract mechanism to permit movement of the jack into engagement with the ground such that only limited rotation of the screw is necessary for elevating the tongue of a trailer for disengaging a coupler on the trailer from a trailer hitch. The screw-type jack incorporates an improved handle which is rotatable about a horizontal axis between an active position for rotating the screw about a vehicle axis and a stowed position wherein the handle engages the body of the jack to prevent rotation of the screw. A support for the screw jack which incorporates improved versatility such that it can be interchangeably used on other jacks and can be used in applications involving uneven and/or non-level surface conditions.

Chambers, U.S. Pat. No. 5,273,256, discloses a jack for lifting a camper from the bed of a pick-up truck that includes a ram with a foot which is normally disposed in a retracted position spaced above the ground to provide clearance during travel of the truck. After the foot has been lowered into contact with the ground, a hand crank is turned and rotates a ball screw which co-acts with a ball nut to cause the ram to lift the camper from the truck. By releasing a latch, the retracted foot may be lowered quickly into contact with the ground without turning the crank and simply by stepping on and pushing downwardly against the foot to effect turning of the ball screw.

Shechet et al., U.S. Pat. No. 5,394,731, discloses a method for in situ quantitative testing of damping characteristics of vehicle suspension systems, the primary element of which is the shock absorber. The method includes: extending the suspension system a C predetermined amount at one or two wheels by raising the vehicle body; dropping the vehicle body in an unimpeded manner; measuring and recording the vehicle body motion with respect to the top of the wheels; and comparing and evaluating the measured performance against the performance of the vehicle suspension system when it was operating properly. A vehicle raiser/dropper is included comprising a scissors jack modified with a positive release split nut release mechanism. The vehicle body motion with respect to the top of the wheel is measured and recorded on a wheel mounted assembly which is coupled to the vehicle body by a motion coupling arm which in turn is attached to the body by a magnet or suction cup. Two recording methods are described; a wheel-mounted constant speed turntable with a unique pencil mounting which is coupled to the vehicle body by the motion coupling arm; and a wheel-mounted angle sensor which produces an electrical signal which is then recorded on an external recorder or computerized equipment. Comparison and evaluation of the recorded vehicle motion with respect to the top of the wheel is done by overlaying the same type of recorded information made by the equivalent equipment when the vehicle suspension system was operating properly, thereby permitting detailed evaluation of the differences.

Sims, U.S. Pat. No. 5,421,555, discloses a quick release trailer jack comprising a vertical support mast extending through a jack body. Pinion and worm gears housed in the body couple a crank to a rack gear on the mast for vertically raising and lowering the mast relative to the trailer. A plunger coaxial with the pinion gear permits an operator to axially translate the pinion gear lateral the mast axis, thereby decoupling the crank from the rack gear. The pinion gear slides into a cylindrical cavity containing a biasing spring which returns the pinion gear into its normal position, re-coupling the crank and the rack, when the operator releases the plunger.

Rasmussen, U.S. Pat. No. 5,984,353, discloses a quick-release arrangement that includes a coupler adapted to slidably engage a braked upper drive screw and to slidably engage a lower drive screw. The lower drive screw is coupled to an associated jack leg such that when the upper drive screw, the coupler, and the lower drive screw are coupled together, the jack leg is braked. A spring urges the coupler into engagement with the lower drive screw. A cam member supports the downwardly-biased coupler and permits the coupler to be cammed upward against the spring bias force such that the coupler slides along the upper drive screw and, thus, out of engagement with the lower drive screw. When it is desired to release the jack leg from the braking control of the upper drive screw to thereby permit rapid lowering of the jack leg to the ground, a cam lever is used to easily overcome the spring bias force and effect camming. Inadvertent camming is prevented because the spring bias force is not overcome by normal vibration, jolting or jarring. Braking control of the upper drive screw can be effected in various manners. For example, the upper drive screw can be coupled to a motor that provides an inherent brake mechanism. Alternatively, a mechanical braking mechanism can provide braking control to the upper drive screw such that operation of the cam member to disengage the upper drive screw from the lower drive screw releases the lower drive screw from the braking control and permits the jack leg to be rapidly lowered to the ground. The present invention provides such a mechanical braking mechanism that cooperates with the quick-release arrangement for use when necessary or desired.

Green, U.S. Pat. No. 7,216,851, discloses a method and apparatus for providing a trailer jack mount. The subject invention also pertains to a method and apparatus for providing a trailer jack mount for use with towable trailers. The subject invention is advantageous for use with trailers, such as utility trailers, which are frequently moved between various locations. The subject apparatus can also enable the mounting of a trailer jack to a trailer such that the trailer jack can quickly transition up or down relative to the trailer. In a specific embodiment, the subject invention includes a first piece mountable to a trailer and a second piece to which a trailer jack can be secured. In this embodiment, the subject apparatus also includes means for securely attaching the second piece to the first piece and allowing the second piece to pivot relative to the first piece. Advantageously, the subject invention can either be retrofitted to an existing trailer with jack, or installed at original manufacture. In another specific embodiment, the second piece is slidably attached to the first piece to allow an individual to adjust the height of the trailer jack.

The related art described above discloses split nuts as well as applications for split nuts, such as for vehicle jacks. However, the related art fails to disclose a selectively engagable nut apparatus capable of quick, releasable engagement with a threaded shaft or screw. In addition, the related art fails to disclose such an apparatus that may be used in a wide range of devices in various fields. The present disclosure distinguishes over the related art providing heretofore unknown advantages as described in the following summary.

### BRIEF SUMMARY OF THE INVENTION

This disclosure teaches certain benefits in construction and use which give rise to the objectives described below.

Selectively engagable nuts, sometimes referred to as “split nuts,” are internally threaded and comprise at least two portions which cooperate for quick releasable engagement with a screw. Nuts and screws are extensively employed in virtually every technology involving mechanical configurations. Often, the screws are long, such as the screws on lathes, drill press limit screws, and scissor jack screws. Thus, it is readily seen that in such applications, removal of a conventional nut, or repositioning of a screw in a conventional nut, requires numerous revolutions of the nut or screw. This problem is not new, and a variety of efforts have been made to overcome this difficulty, including the use of a split nut which can be mounted and removed at a selected position on a screw. However, prior art split nuts fail to provide a quick and easy way of selectively engaging and disengaging a nut with a screw without sacrificing some degree of speed or engagement strength. Furthermore, there is a need for assuring that a split nut will not disengage its screw without warning as such a failure may cause serious damage.

The present invention solves these problems by providing a selectively engagable nut having two halves that are able to move apart for disengagement with a screw and to move together to reengage. The two nut halves are driven by pins extending into slots on the nut halves; the pins mounted in a rotating collar adjacent to the nut halves. The collar is rotated by a rotating plate that provides further slots engaging the pins. Advantageously, the plate has fingers that rotate into place on the nut halves so that they cannot move apart without rotation of the plate.

The nut and its assembly may be mounted on a scissor jack replacing a conventional jack nut so that the jack may be quickly extended or retracted when the nut is disengaged, and yet the jack may be operated conventionally when the nut is engaged with the screw.

A primary objective inherent in the above described apparatus and method of use is to provide advantages not taught by the prior art.

Another objective is to provide a selectively engagable nut apparatus capable of engagement and disengagement with a screw.

A further objective is to provide such an apparatus that is capable of securing the nut in a closed attitude for ensuring screw engagement.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1 is a perspective view of the presently described apparatus in one embodiment showing a screw which may be considered a part of the apparatus or a merely used therewith;

FIG. 2 is a perspective exploded view thereof showing the screw broken away for clarity;

FIG. 3 is a perspective view of the presently described apparatus as employed with and made a part of a trunion;

FIG. 4 is a top plan view of FIG. 3;

FIGS. 5A and 6A are cross-sectional views thereof taken along line A-A in FIG. 4 showing a nut/screw-engaged and nut/screw-disengaged positions respectively, and trunion mounting screws; and

FIGS. 5B and 6B are cross-sectional views thereof taken along line B-B in FIG. 4 showing the nut/screw-engaged and the nut/screw-disengaged positions respectively, as well as the trunion mounting screws.

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications to what is described herein without departing from its spirit and scope. Therefore, it should be understood that what is illustrated is set forth only for the purposes of example and should not be taken as a limitation on the scope of the present apparatus and its method of use.

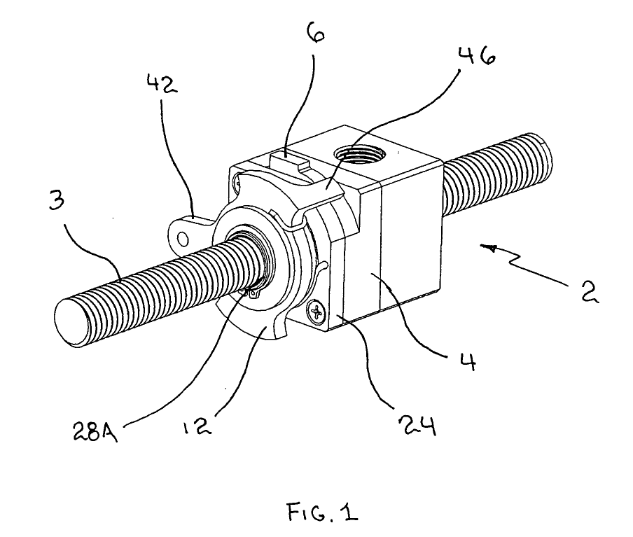

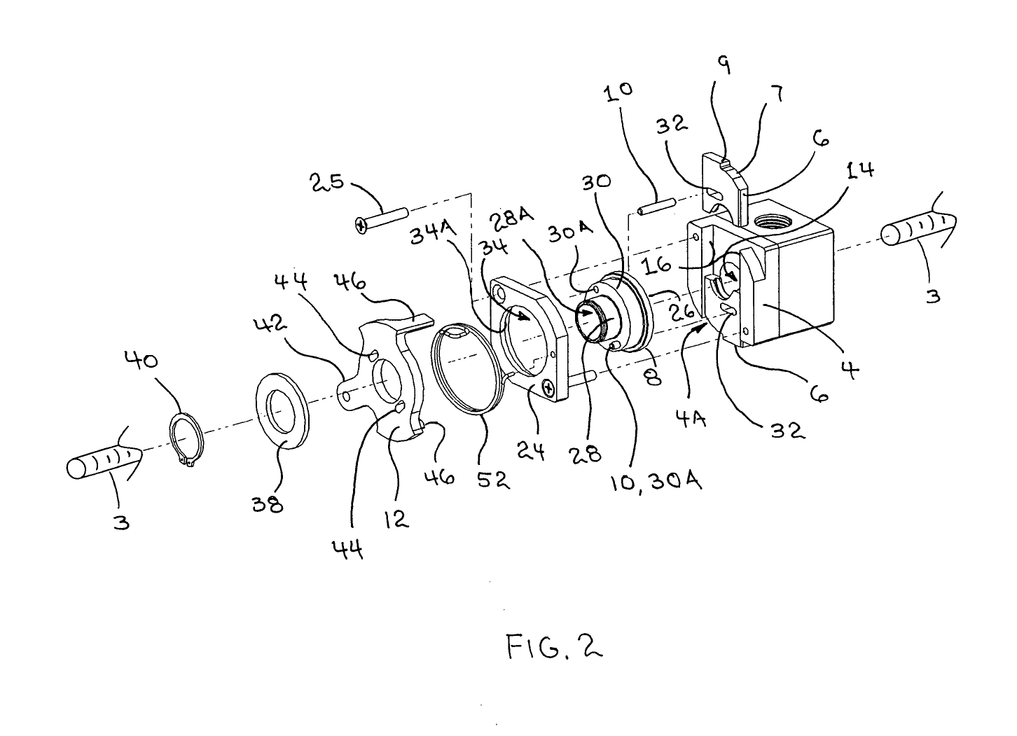

Described now in detail is a selectively engagable fastener set referred to herein as a nut positioning apparatus 2. As shown in FIGS. 1 and 2, the apparatus 2 comprises a guide plate 4, a nut comprising two halves 6, a carrier 8, a pair of spaced apart pins 10, and an actuation plate 12. The guide plate 4 preferably has opposing front and rear surfaces 4A and 4B and a medial guide plate aperture 14 that extends between these surfaces 4A, 4B. In addition, the front surface 4A has a pair of laterally spaced apart nut guiding surfaces 16, the function of which will become apparent below.

The nut positioning apparatus 2 operates to engage and disengage a screw 3, such as a jack screw as shown in FIG. 2.

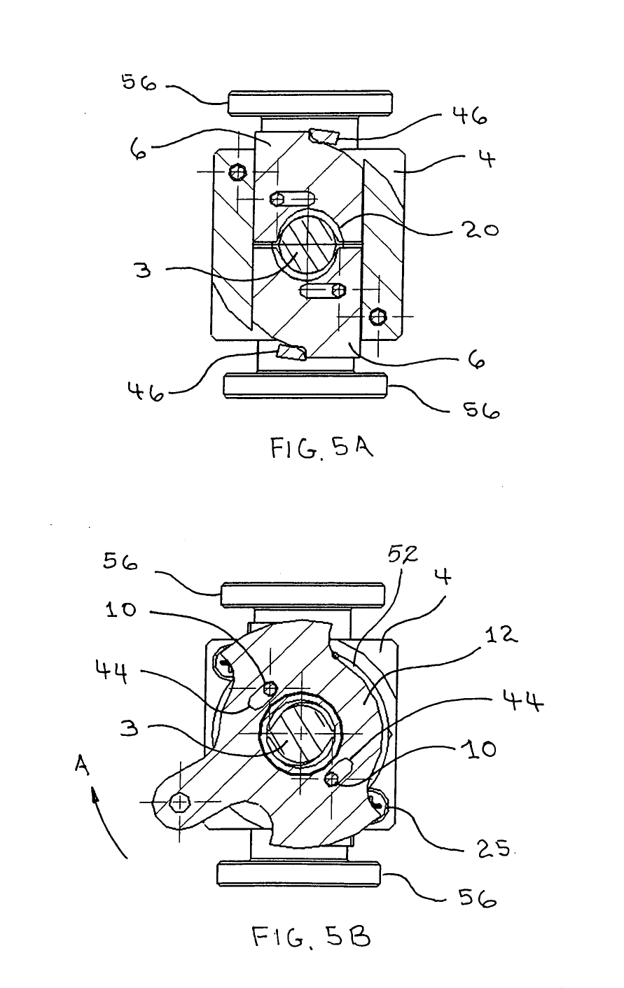

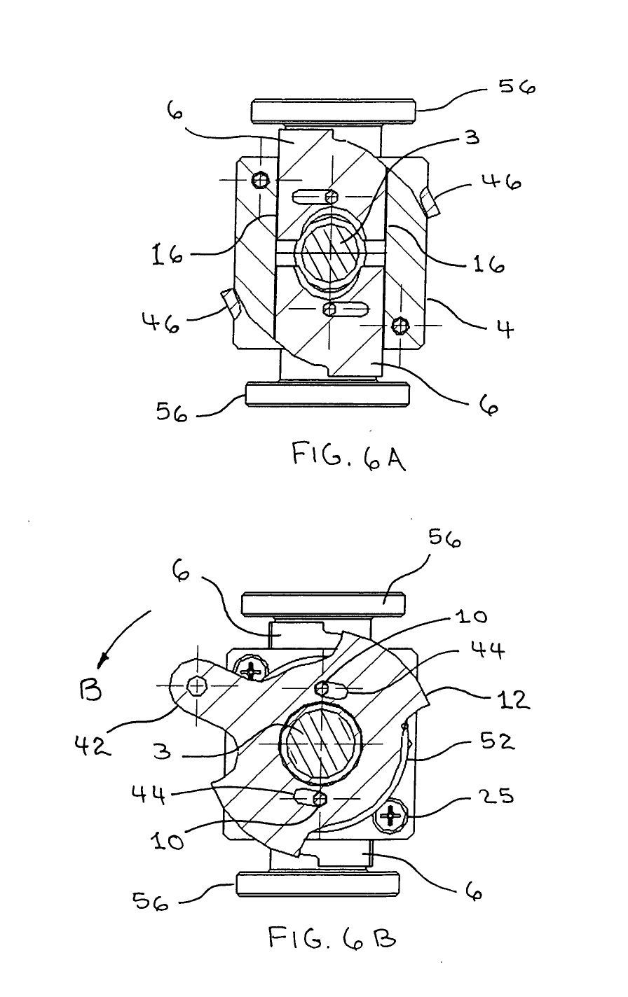

As shown in FIG. 2, the nut halves 6 are positioned in slidingly abutting contact with the front surface 4A of the guide plate 4, between the nut guiding surfaces 16. The nut halves 6 are thus capable of sliding between a position of mutual contact (FIG. 5A), and a position of mutual separation (FIG. 6A). When positioned in mutual contact, the nut halves 6 define a threaded nut aperture 20, coaxial with the guide plate aperture 14 and engaged with a screw 3 which is also coaxial with nut aperture 20. When the nut halves 6 are positioned in mutual separation, screw 3 is disengaged with the nut aperture 20 and therefore free to translate linearly along its own longitudinal axis without rotating.

The carrier 8 is secured to the front surface 4A of the guide plate 4 by a carrier plate 24, and sandwiches the nut halves 6 therebetween. Carrier plate is secured in place using screws 25. As shown in FIG. 2, the carrier 8 is comprised of a base portion 26, an elongate cylindrical shaft portion 28 integral with the base portion 26, and a separate rotational ring portion 30, rotationally engaged about the shaft portion 28. The carrier 8 has a carrier aperture 28A there through and coaxial with the guide plate aperture 14. The rotational ring portion 30 and the base portion 26 provide pin apertures 30A configured for securely engaging a pair of elongate pins 10. One end of each one of the pins 10 extends from the base portion 30 into engagement within a first slot 32 in one of the nut halves 6, as shown in FIG. 2, the function of which is described below. The carrier plate 24 defines a carrier plate aperture 34 having a diameter for accepting the shaft portion 28 of the carrier 8. An annular internal flange 34A within the carrier plate aperture 34 sandwiches the base portion 26 of carrier 8 relative to surface 4A of the guide plate 4.

As shown in FIGS. 1 and 2, the actuation plate 12 defines an actuation plate aperture 36 coaxial with guide plate aperture 14, and is rotatably engaged on shaft portion 28 of carrier 8. Preferably, the actuation plate 12 is retained on shaft portion 28 by a washer 38 and a retainer ring 40. Preferably, the actuation plate 12 provides a laterally extending radial handle 42 for manual rotation of actuation plate 12. Another end of each one of the pins 10 extends from carrier 8 engaging one of a pair of second slots 44 in actuation plate 12. A pair of locking fingers 46 integral with actuation plate 12 extend longitudinally in alignment with screw 3. The fingers 46 extend into contact with arcuate surfaces 7 of nut halves 6 and are able to make contact with nut stop surfaces 9 thereby limiting the range of rotation of the actuation plate 12. Thus, when the fingers 46 are in abutting contact with the stop surfaces 9, the nut halves 6 are locked in mutual contact. When the fingers 46 are rotated away and to one side of nut halves 6, the nut halves 6 are free to translate into the position of mutual separation.

With nut halves 6 in their mutually abutting position, as shown in FIG. 5A, where they are engaged with screw 3, actuation plate 12 is positioned as shown in FIG. 5B which places fingers 46 in positions which prevent any motion of nut halves 6. When it is desired to disengaged nut halves 6 from screw 3, actuation plate 12 is rotated clockwise as shown by arrow “A.” Slots 44 permit an initial rotation of plate 12 with no effect on pins 10 but this initial rotation moves fingers 46 into lateral positions that permit nut halves 6 to move apart. As carrier 8 rotates further in the direction of arrow “A”, pins 10 are also forced to move from their starting position oriented at about 45° relative to the vertical, as shown in FIGS. 5A and 5B, to their final position of vertical alignment, as shown in FIGS. 6A and 6B. This pin movement drives nut halves 6 apart in vertical translation as restricted by surfaces 16, as shown in FIG. 6A. It is noted that fingers 46 are positioned laterally so that they do not interfere with movement of nut halves 6.

When it is desired to reengage nut halves 6 with screw 3, plate 12 is moved in a counter-clockwise direction as shown by arrow “B” and this rotational motion terminates with fingers 46 in positions shown in FIG. 5A and with the nut halves 6 abutting and engaged with screw 3. Spring 52 is engaged with the carrier plate 24 and the actuation plate 12, and urges the nut halves 6 into the position of mutual contact. This is a safety feature to assure that the nominal, or rest state, of the present apparatus is with nut/screw engagement.

While the nut aperture 20 is configured for threadably engaging the screw 3, the inside diameter of each of the retainer ring 40, washer 38, actuation plate aperture 36, shaft aperture 28A, and guide plate aperture 14 is slightly larger than the diameter of the screw 3. Thus, when the nut halves 6 are in the position of mutual separation, the screw 3 is able to move freely in translation along its own axis. Therefore, the present invention is capable of quick, selective, releasable engagement with the screw 3.

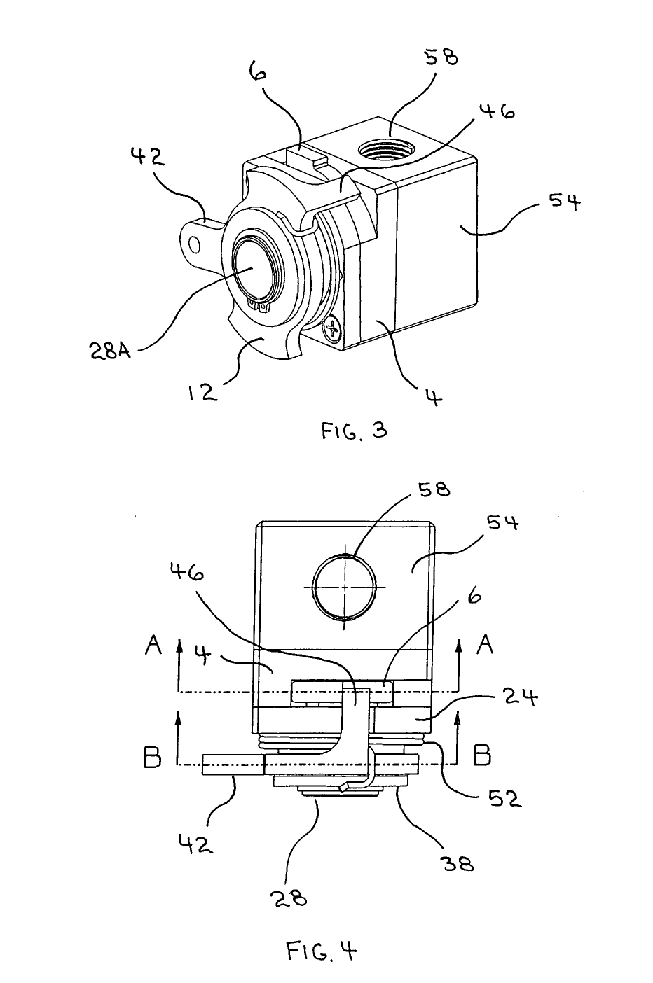

Scissor jacks are commonly used for supporting and leveling recreational vehicles when they are parked. When traveling, such jacks are fully retracted. To employ the scissor jack, normally, its screw must be rotated until the jack is extended into contact with the ground surface. Obviously, this takes considerable effort and time in rotating the screw many times. With the present invention employed in the common scissor jack, replacing the typical one-piece screw, the handle 42 is moved to the position shown in FIG. 6B thereby disengaging nut halves 6 and allowing the jack to extend quickly into contact with the ground surface. Then, with handle 42 moved to the position shown in FIG. 5B, the nut halves 6 are once again engaged with screw 3 and the jack screw can be further extended to level the recreational vehicle. When ready to move the vehicle, the nut halves 6 can be disengaged, jack collapsed by manually lifting it, and nut halves 6 again engaged with the jack screw 3. This procedure obviously takes much less time in both employing the scissor jack, and in folding it for travel than would be necessary with cranking it to full extension and again cranking it to full retraction. As shown in FIGS. 3 and 4, the above described exemplary use of the present invention is with a trunion 54 where guide plate 4 is integral, or make a part of the trunion 54 which is mounted at a hinge point of a scissor jack in place of a standard one-piece nut using screws 56 which are engaged with threaded holes 58 on top and bottom of trunion 54 (FIGS. 3, 4, 5A, 5B, 6A and 6B). When the nut halves 6 are positioned in mutual contact (FIG. 5A), the operation of the scissor jack is exactly the same as with the standard one-piece nut. It should be noted that this is merely an exemplary use of the present invention, as the apparatus 2 may be used in conjunction with essentially any device that utilizes a screw and nut configuration.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A selective engagable fastener apparatus comprising:
a guide plate;
a nut comprising a first and a second nut halves, the nut halves slidingly abutting the guide plate between a position of mutual separation, and a position of mutual contact, wherein the position of mutual contact establishes a threaded nut aperture of the nut;
a carrier secured to the guide plate;
a pair of spaced apart pins secured to a rotational portion of the carrier, with each one of the pins slidingly engaged within one of a pair of spaced apart first slots in the nut; and
an actuation plate rotatably engaged on the carrier, the spaced apart pins slidingly engaged within a pair of second slots in the actuation plate;
wherein rotation of the actuation plate drives the nut halves in translation between the positions of mutual separation and mutual contact.

2. The selective engagement apparatus of claim I further comprising a pair of locking fingers integral with the actuation plate, the actuation fingers positioned for inhibiting translation of the nut halves when the nut halves are in mutual contact.

3. The selective engagement apparatus of claim 1 further comprising a spring engaged with the carrier and the actuation plate, the spring urging rotation of the actuation plate placing the nut halves into the position of mutual contact.

4. The selective engagement apparatus of claim 1 wherein the guide plate, carrier and actuation plate each provide apertures aligned with the nut aperture.

5. The selective engagement apparatus of claim 1 wherein the guide plate has laterally spaced apart nut guiding surfaces, the nut positioned for sliding therebetween.

6. The selective engagement apparatus of claim 1 wherein the guide plate is a part of a trunion assembly.

7. The selective engagement apparatus of claim 1 further comprising a screw extensive through the nut aperture.

8. The selective engagement apparatus of claim 4 further comprising a screw extensive through the apertures of the guide plate, carrier, actuation plate and the nut.

9. A selective engagement screw apparatus comprising:
a guide plate;
a nut comprising a first and a second nut halves, the nut halves slidingly abutting the guide plate between a position of mutual separation, and a position of mutual contact, wherein the position of mutual contact establishes a threaded nut aperture in the nut;
a carrier secured to the guide plate;
a pair of spaced apart pins secured to a rotational portion of the carrier, with each one of the pins slidingly engaged within one of a pair of spaced apart first slots in the nut; and
an actuation plate rotatably engaged on the carrier, the spaced apart pins slidingly engaged within a pair of second slots in the actuation plate;
the guide plate, carrier and actuation plate each provide apertures aligned with the nut aperture; and
a linear threaded screw positioned within the nut, guide plate, carrier and actuation plate apertures;
whereby rotation of the actuation plate drives the nut halves in translation between the positions of mutual separation, for releasing the nut from the screw, and mutual contact for engaging the threaded nut aperture with the threaded screw.

10. The selective engagement apparatus of claim 8 further comprising a pair of locking fingers integral with the actuation plate, the actuation fingers positioned for inhibiting translation of the nut halves when the nut halves are in mutual contact.

11. The selective engagement apparatus of claim 8 further comprising a spring engaged with the carrier and the actuation plate, the spring urging the nut halves into the position of mutual contact.

12. The selective engagement apparatus of claim 8 wherein the guide plate has laterally spaced apart nut guiding surfaces, the nut positioned for sliding therebetween.

13. The selective engagement apparatus of claim 8 wherein the guide plate is integral with a trunion housing.

14. A selective engagement screw apparatus comprising:
a guide plate;
plural nut portions slidingly abutting the guide plate between a position of mutual contact between the nut portions, and a position of mutual separation there between, wherein the position of mutual contact establishes a threaded nut aperture in the plural nut portions;
a carrier rotationally secured to the guide plate, the carrier having at least two pins extending therefrom, said pins engaging slots in the nut portions; and
an actuation plate rotatably engaged on the carrier and further engaging the at least two pins;
whereby, rotation of the actuation plate also rotates the carrier, thereby moving the at least two pins in a direction for separating the nut portions, and alternatively in a direction for bringing the nut portions into mutual contact.

15. The selective engagement apparatus of claim 14 further comprising a linear screw positioned coaxially with the threaded nut aperture.

16. The selective engagement apparatus of claim 14 further comprising plural locking fingers integral with the actuation plate, the actuation fingers extending into contact with the nut portions thereby preventing the nut portions from parting when the nut portions are in mutual contact.

17. The selective engagement apparatus of claim 14 further comprising a spring positioned to urge the the nut halves into the position of mutual contact.

18. The selective engagement apparatus of claim 14 wherein the guide plate has laterally spaced apart nut guiding surfaces, the nut positioned for sliding therebetween.

19. The selective engagement apparatus of claim 14 wherein the guide plate is integral with a trunion housing.
